(19) United States
(12) Patent Application Publication
(10) Pub. No.: US 2007/0195794 A1
(43) Pub. Date: Aug. 23, 2007

(54) Virtual lan system and node device

(75) Inventors: Norihito Fujita, Tokyo (JP); Toshio Koide, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/573,623

(22) PCT Filed: Aug. 9, 2005
(86) PCT No.: PCT/JP05/14889

§ 371 Date: Apr. 2, 2007

(30) Foreign Application Priority Data
Aug. 11, 2004 (JP) 2004-234370

(51) Int. Cl. H04L 12/56

(52) U.S. Cl. 370/395.53

(57) ABSTRACT

A node A21 sets a communication tunnel for encapsulating a data link packet with other nodes joining in a virtual LAN to a peer-to-peer type, and comprises a packet forward table A2141 for forwarding the data link layer packet received from a communication tunnel to another communication tunnel. In addition, the node A21 reconfigures the topology of the virtual LAN using a topology calculation unit A2153 when another node withdrew from the virtual LAN, and opens or removes communication tunnels according to the reconfigured topology using a tunnel control unit A2152.

### FIELD OF THE INVENTION

The present invention relates to a virtual LAN system, and more particularly to a virtual LAN system and a node device allowing, in a virtual LAN constructed virtually on a physical network using a communication tunnel, the virtual LAN to be provided without requiring a virtual hub, by setting the communication tunnel between the joining nodes to peer-to-peer type.

### DESCRIPTION OF THE RELATED ART

As described in Patent Bulletin 3343064 (page 26, FIG. 16), this type of virtual LAN (Local Area Network) system is conventionally used as a system that provides a virtual LAN environment via a pseudo-network adapter and a tunnel server. Nodes joining in a virtual LAN of this type have a virtual adapter (a virtual interface, also referred to as a virtual NIC), and the virtual adapter encapsulates the data link layer net packets (e.g., Ethernet™ packets) to send and receive the packets between itself and a tunnel server (also referred to as a virtual hub or a virtual bridge), thereby emulating a virtual LAN environment on a physical network.

Referring to FIG. 1, a conventional virtual LAN system will be specifically described. The conventional virtual LAN system consists of nodes A11-A13, a virtual hub B1 and a backbone network C1.

The node A11 includes an application A111, a TCP/IP processing unit A112, a physical interface A113 and a virtual interface A114. The application A111 is an application that sends and receives data using a TCP/IP communication function that is provided to the node A11, and examples include browsers and mailers. The TCP/IP processing unit A112 has a function to process the transport layers and network layers required for TCP/IP communication, and is usually provided as a standard functionality of a kernel. Corresponding to the physical link provided to the node A 11 the physical interface A113 is provided, having a function to transport, via data link layer media, IP packets that are sent and received by the TCP/IP processing unit A112.

The visual interface A114 is an interface that is emulated so that, to the TCP/IP processing unit A112, the appearance is same as the physical interface A113, although no corresponding physical link actually exists. The virtual interface A114 includes therein an encapsulating unit A1141. Packets that are sent and received through the virtual interface A114 are encapsulated by the encapsulating unit A1141, and, outside the virtual interface A114, transported on a communication tunnel Ct11 in a packet format such as Ethernet™ over IP, Ethernet over UDP, and Ethernet over IPsec, for example. In other words, the communication tunnel Ct11 becomes a virtual link that connects the node A11 and the virtual hub B1 in the virtual LAN. The communication tunnel Ct11 is established with the virtual hub B1. These packets that are sent and received through the virtual interface A114 flow through the backbone network C1 using the physical link corresponding to the physical interface A113.

The virtual hub B1 includes a tunnel terminating unit B11 and a bridging unit B12. The tunnel terminating unit B11 terminates the communication tunnels Ct11-Ct13 respectively associated with the nodes A11-A13 and decapsulates the received packets before passing the packets to the bridging unit B12. Based on the destination MAC addresses of the received packets, the bridging unit B12 performs bridging and returns these packets to the tunnel terminating unit B11 to be forwarded to the corresponding communication tunnel. In other words, the virtual hub B1 provides, in a virtual LAN, functions similar to hubs in the Ethernet.

A problem of the prior art is that a virtual hub is needed to provide a virtual LAN.

In order to provide a virtual LAN, a virtual hub must be readied, for use by nodes joining in the virtual LAN. In other words, since at least one virtual hub is needed even when providing a small virtual LAN consisting of a few nodes, in view of operational costs for setting up and managing the virtual hub, starting with a small scale is difficult.

Furthermore, since a communication within the virtual LAN is always via the virtual hub, traffic loads and processing loads on the virtual hub increase proportionally to the traffic within the virtual LAN, leading to a scalability problem.

Furthermore, the virtual LAN itself cannot be used in the event of a failure of the virtual hub and in the event of a failure of a link where the virtual hub is contained in a backbone network. In other words, since the virtual hub becomes a single failure point, there is a problem on the reliability of a system.

It is an object of the present invention to provide a virtual LAN system that does not require a virtual hub, and a node device for the system.

### SUMMARY OF THE INVENTION

According to the first a virtual LAN system of the invention, the virtual LAN system for providing a virtual LAN which is a LAN constructed virtually by encapsulating a data link layer packet using a communication tunnel, wherein a node device joining in the virtual LAN comprises a virtual interface for emulating, as a virtual link in the virtual LAN, the communication tunnel for encapsulating the data link layer packet, the virtual interface comprising a plurality of sub-interfaces for terminating communication tunnels established for other node devices in the virtual LAN, and a packet forward table in which sub-interfaces are registered from which sub-interface among the plurality of sub-interfaces to send or forward the data link layer packet that the current node device is to send and the data link layer packet received from another node device in the virtual LAN, according to a virtual LAN topology in which the node devices joining in the virtual LAN are connected by the communication tunnels, and the data link layer packet that is sent from the node device joining in the virtual LAN to another node device joining in the virtual LAN is configured so as to be delivered through the communication tunnel if the communication tunnel is directly established between the sending/receiving node devices, and delivered through one or more node devices joining in the virtual LAN if the communication tunnel is not directly established between the sending/receiving node devices.

According to a second virtual LAN system of the invention, in the virtual LAN system, the node device joining in the virtual LAN comprises a virtual LAN control unit for, when the node device detects the withdrawal of another node device joining in the LAN from the virtual LAN, recalculating a virtual LAN topology after the withdrawal, and opening and removing the communication tunnel to suit the recalculated virtual LAN topology, and for changing the setting of the packet forward table.

According to a third virtual LAN system of the invention, in the virtual LAN system, the node device joining in the virtual LAN comprises a virtual LAN control unit for, when the node device detects the join of a new node device in the virtual LAN, recalculating a virtual LAN topology after the join, and opening and removing the communication tunnel to suit the recalculated virtual LAN topology, and for changing the setting of the packet forward table.

According to a fourth virtual LAN system of the invention, in the virtual LAN system, a node ID unique in the virtual LAN is assigned to the node device joining in the virtual LAN, an outgoing sub-interface ID associated with a MAC address of the node device joining in the virtual LAN, a destination node ID and a source node ID is registered with the packet forward table of the node device joining in the virtual LAN, the data link layer packet is encoded with the node ID of the source node and the destination node of the data link layer packet during encapsulation, and the virtual interface forwards the data link layer packet based on the node IDs of the encapsulated source node and destination node.

According to a first node device of the invention, the node device comprises

a virtual interface for emulating, as a virtual link in the virtual LAN, a communication tunnel for encapsulating a data link layer packet, wherein

the virtual interface comprising a plurality of sub-interfaces for terminating communication tunnels established for other node devices in the virtual LAN, and a packet forward table in which sub-interfaces are registered from which sub-interface among the plurality of sub-interfaces to send or forward the data link layer packet that the current node device is to send and the data link layer packet received from another node device in the virtual LAN, according to a virtual LAN topology in which the node devices joining in the virtual LAN are connected by the communication tunnels, wherein

the virtual interface sending or forwarding the data link layer packet that the current node is to send and the data link layer packet received from another node in the virtual LAN from a sub-interface that is determined by referring to the packet forward table.

According to a second node device of the invention, the node device comprises a virtual LAN control unit for, when the node device detects the withdrawal of another node device joining in the LAN from the virtual LAN, recalculating a virtual LAN topology after the withdrawal, and opening and removing the communication tunnel to suit the recalculated virtual LAN topology, and for changing the setting of the packet forward table.

According to a third node device of the invention, the node device comprises a virtual LAN control unit for, when the node device detects the join of a new node device in the virtual LAN, recalculating a virtual LAN topology after the join, and opening and removing the communication tunnel to suit the recalculated virtual LAN topology, and for changing the setting of the packet forward table.

According to a third node device of the invention, in the node device, an outgoing sub-interface ID associated with a MAC address of the node device joining in the virtual LAN, a destination node ID and a source node ID is registered with the packet forward table, the data link layer packet is encoded with the node ID of the source node and the destination node of the data link layer packet during encapsulation, and the virtual interface forwards the data link layer packet based on the node IDs of the encapsulated source node and destination node.

According to a fourth node device of the invention, the node device comprises a bootstrap unit that has a function to obtain information as to for which node that is already joining in the virtual LAN the communication tunnel should be opened, when the node device tries to join in the virtual LAN.

### BRIEF DESCRIPTION OF THE DRAWINGS

FIG. 1 is a block diagram illustrating a configuration of a conventional virtual LAN system;

FIG. 2 is a block diagram illustrating a configuration of a mode of implementation of the present invention;

FIG. 3 is a diagram illustrating an example of a packet forward table according to the mode of implementation of the present invention;

FIG. 4 is a diagram illustrating a virtual LAN topology that is configured according to the mode of implementation of the present invention;

FIG. 5 is a flow chart illustrating an operation of the mode of implementation of the present invention;

FIG. 6 is a diagram illustrating an example of topology construction and reconfiguration according to the mode of implementation of the present invention;

FIG. 7 is a diagram illustrating another example of a packet forward table according to the mode of implementation of the present invention;

FIG. 8 is a diagram illustrating an example of a packet format according to the mode of implementation of the present invention;

FIG. 9 is a diagram illustrating the acquisition of the information that is needed to join in the virtual LAN according to the embodiment of the present invention;

FIG. 10 is a diagram illustrating the packet forward table after joining in the virtual LAN according to the embodiment of the present invention; and

FIG. 11 is a diagram illustrating the packet forward table after the reconfiguration of the topology according to the embodiment of the present invention.

### DESCRIPTION OF EMBODIED CONFIGURATION OF THE INVENTION

The mode of implementation of the present invention now will be described in detail by referring to drawings.

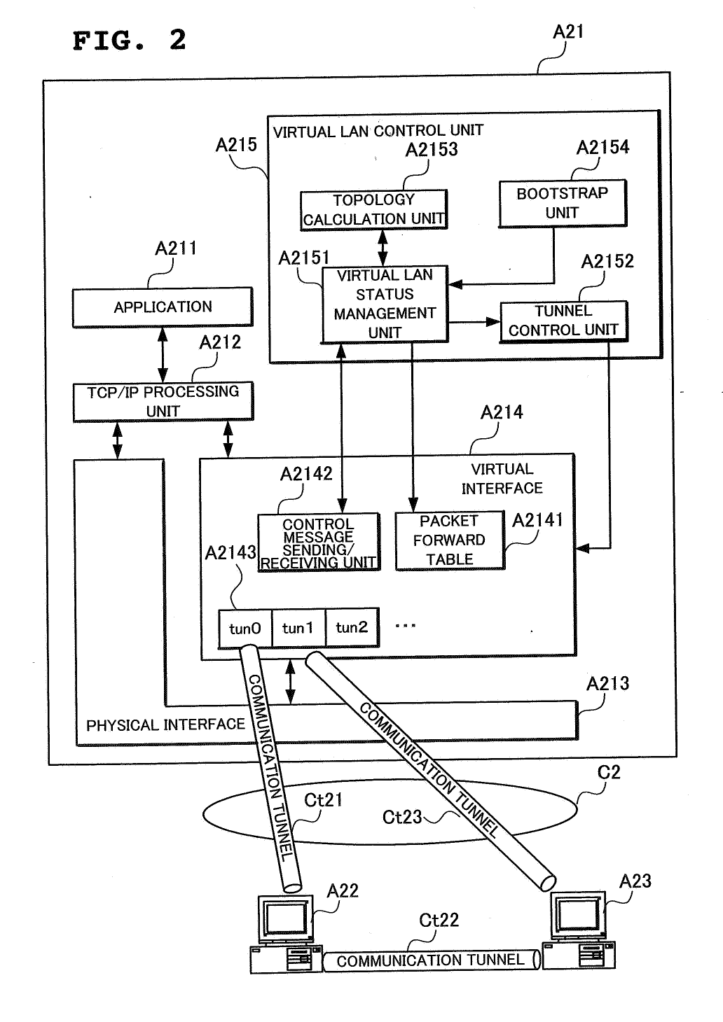

Referring to FIG. 2, the mode of implementation of the present invention consists of nodes A21-A23 and a backbone network C2. Between each node, a virtual link is configured by communication tunnels Ct21-Ct23, and Ethernet packets corresponding to intra-virtual LAN communication are encapsulated and transported. Although FIG. 2 is drawn as if the communication tunnels were generated among three nodes in a fully meshed form, actually, there is no need for the communication tunnels to be generated in such a fully meshed form among the nodes joining in the virtual LAN, and an arbitrary topology for packet forward is configured with communication tunnels between the nodes joining in the virtual LAN, and the packets are forwarded over the topology.

The nodes A21-A23 are nodes that join in the virtual LAN, and are configured by computers having communication functions, such as a personal computer and a PDA. Only the configuration and operation of the node A21 will be described in detail below, but the nodes A22 and A23 also have the same configuration as that of the node A21. The node A21 includes an application A211, a TCP/IP processing unit A212, a physical interface A213, a virtual interface A214 and a virtual LAN control unit A215.

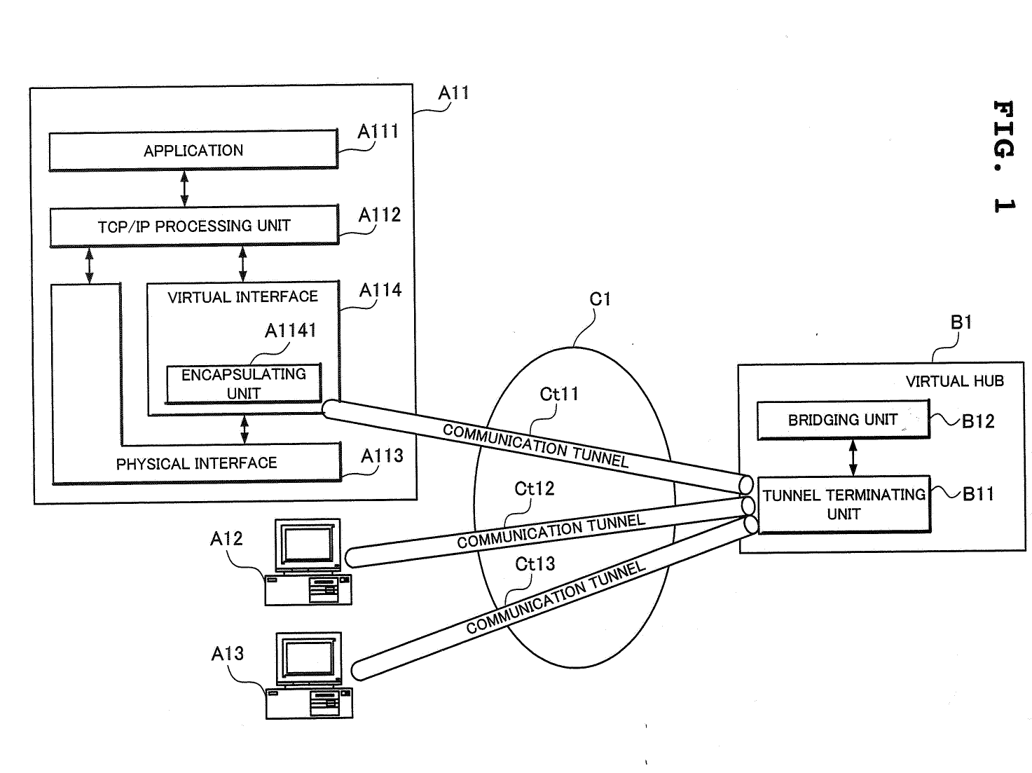

Since the application A211, the TCP/IP processing unit A212 and the physical interface A213 are the same as the application A111, the TCP/IP processing unit A112 and the physical interface A113 in the description of FIG. 1, the descriptions thereof will be omitted.

The virtual interface A214 is emulated in regard to the TCP/IP processing unit A212, as a virtual interface for performing communication within the virtual LAN. The virtual interface A214 includes, as its internal configuration, a packet forward table A2141, a control message sending/receiving unit A2142 and a sub-interface A2143.

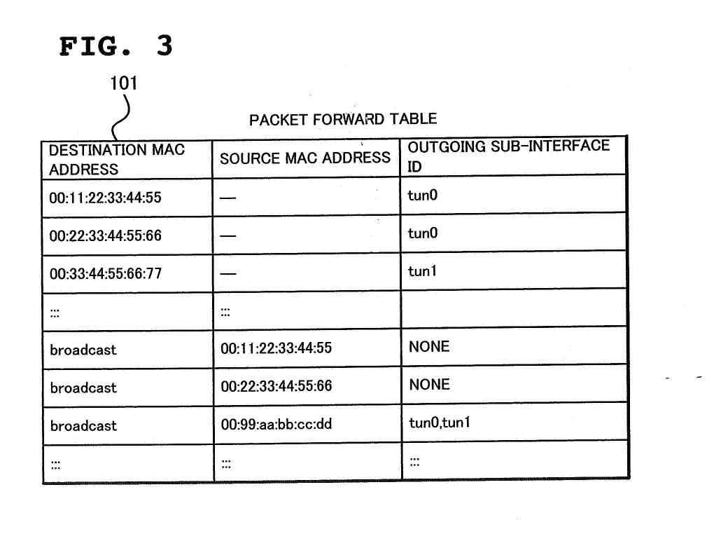

The packet forward table A2141 is a table that indicates, in the virtual interface A214, for packets that are to be sent from the current node, and packets that are received from another node and whose destination MAC address is not the MAC address of the current node, from which sub-interface the packets should be forwarded based on the destination MAC address. The example of the packet forward table A2141 is shown in FIG. 3.

Referring to FIG. 3, for each packet destination MAC address, a corresponding sub-interface ID is recorded in the packet forward table 101. According to the packet forward table 101, it is shown that the packets with destination MAC addresses 00:11:22:33:44:55 and 00:22:33:44:55:66 are sent out from sub-interface tun0, and that the packets with destination MAC address 00:33:44:55:66:77 are sent out from sub-interface tun1. An entry with “broadcast” written in the destination MAC address is an entry corresponding to a broadcast packet (this corresponds to packets with destination MAC address ff:ff:ff:ff:ff:ff, and packets with a destination MAC address that is unclear about where the forward should go to). In the example of the packet forward table 101 shown in FIG. 3, it is shown that, for broadcast cases, the sub-interfaces from which the packets are sent out are different depending on their source MAC addresses (the reason for this will be described below): the packets are terminated at the current node without being forwarded if the source MAC addresses are 00:11:22:33:44:55 and 00:22:33:44:55:66, and the packets are sent out from the sub-interface tun0 and tun1 when the source MAC address is 00:99:aa:bb:cc:dd.

The control message sending/receiving unit A2142 has a function to send and receive control messages for exchanging information about each joining node within the virtual LAN. The control message sending/receiving unit A2142 passes the control information contained in the control message received from another node within the virtual LAN to a virtual LAN status management unit A2151 within the virtual LAN control unit A215. The control information includes information about join and withdrawal of the nodes within the virtual LAN, the ID and MAC address of each joining node, information about the delay and bandwidth between each node. The control information also has a function to send, as a control message to another node, the control information received from the virtual LAN status management unit A2151.

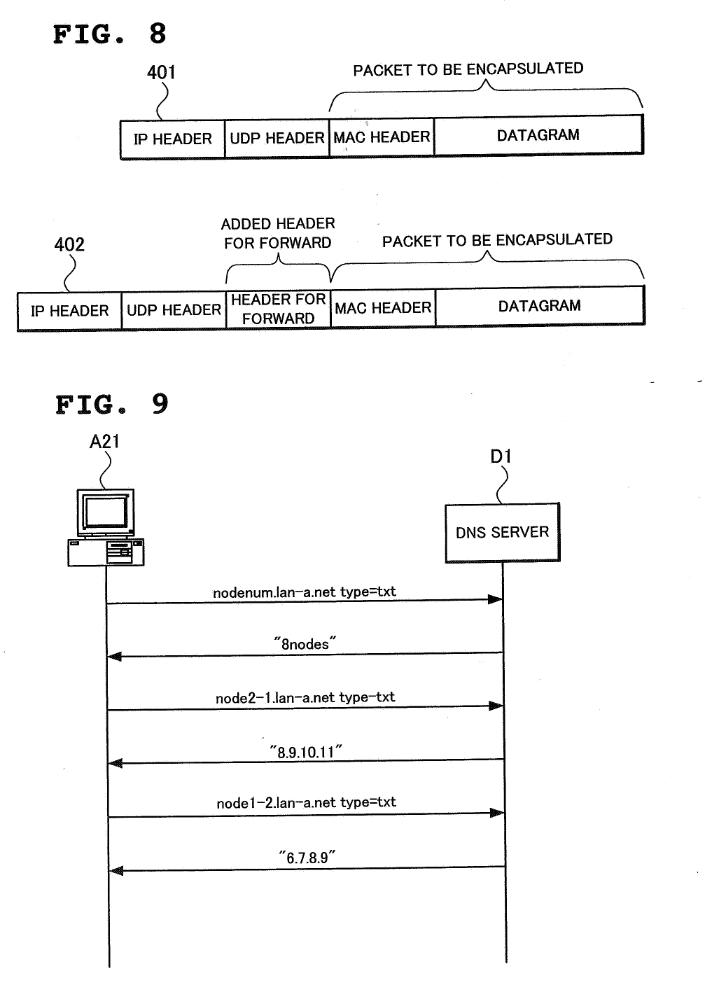

The sub-interface A2143 terminates the communication tunnel established for another node within the virtual LAN, and is materialized as a sub-interface within the virtual interface A214. Even if there are more than one sub-interfaces A2143, the sub-interfaces appear to be one virtual interface to the TCP/IP processing unit A212. The sub-interface A2143 encapsulates the packets sent from the virtual interface A214 to transmit the packets over the communication tunnel(s) established for the sub-interface A2143 and other nodes within the virtual LAN. For the packets that are received at the virtual interface A214, the encapsulation header is removed at the sub-interface A2143, and based on the MAC header encoded within the encapsulation header, the virtual interface A214 either receives the packets at the current node or forwards the packets. Outside the sub-interface A2143, for example, the packets are transported over the communication tunnels Ct21-Ct23 in a packet format such as Ethernet over IP and Ethernet over UDP. The packet format 401 in FIG. 8 represents the Ethernet over UDP packet format.

The virtual LAN control unit A215 has a function to control the packet forward topology within the virtual LAN in which the node A21 joins. The virtual LAN control unit A215 includes, as its internal configuration, the virtual LAN status management unit A2151, a tunnel control unit A2152, a topology calculation unit A2153 and a bootstrap unit A2154.

The virtual LAN status management A2151 has a function to manage the status in the virtual LAN in which the node A21 joins. The status in the virtual LAN includes the number of nodes joining in the virtual LAN, information on the nodes that are directly connected from the current node via the communication tunnel (e.g., node IDs, MAC addresses and physical IP addresses), and information on the resource between each node (e.g., delay and bandwidth). The virtual LAN status management unit A2151 has a function to rewrite the contents of the packet forward table A2141 based on the these data, and a function to open and remove communication tunnels for the other nodes through the tunnel control unit A2152 to change the topology of the virtual LAN. When changing the topology, communication tunnels are opened and removed based on a topology calculated through the topology calculation unit A2153.

The tunnel control unit A2152 controls the opening and removal of the communication tunnel for the virtual interface A214, based on the directive from the virtual LAN status management unit A2151.

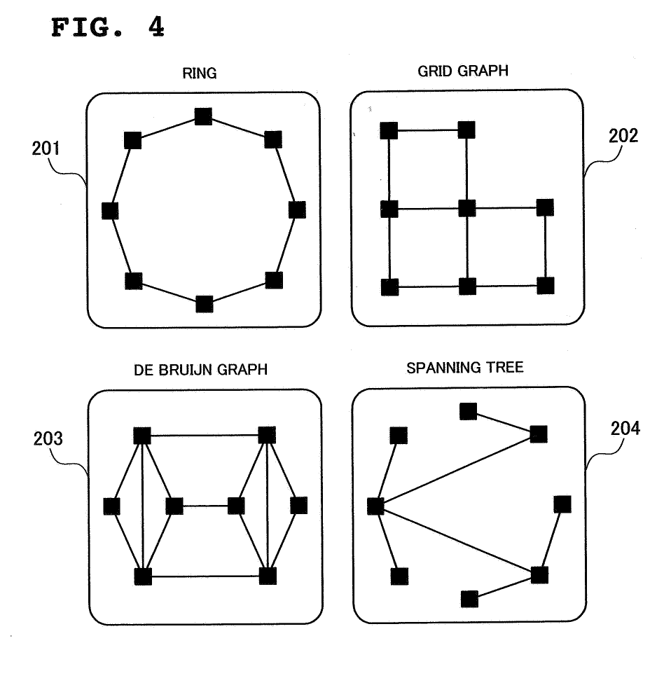

The topology calculation unit A2153 calculates the topology according to the communication tunnel for forwarding broadcast packets and unicast packets within the virtual LAN. Information on each node within the virtual LAN and information on the resource between each node, which are kept in the virtual LAN status management unit A2151, are used in the topology calculation. Examples of topology include a ring topology, a grid graph topology, a de Bruijn graph topology and a spanning tree topology. These topologies are shown in 201-204 in FIG. 4. A spanning tree refers to a topology in which links are provided between nodes so that no closed path is created.

The bootstrap unit A2154 performs initialization needed by the node A21 when joining in the virtual LAN. An example of initialization is the method of connecting to any of the nodes joining in the virtual LAN to obtain information needed to join in the virtual LAN. In this case, it is necessary that information such as the IP address of any of the nodes joining in the virtual LAN is preset in the bootstrap unit A2154. The information needed to join in the virtual LAN includes a node ID held by a newly joining node when the node newly joins in the virtual LAN, and a base IP address (IP address that is assigned on the actual physical network) of a partner node for which the newly joining node should open a communication tunnel. In addition, the method of obtaining the information needed to join in the virtual LAN from a DNS (Domain Name System) server using an FQDN (Full-Qualified Domain Name) corresponding to the virtual LAN can be considered.

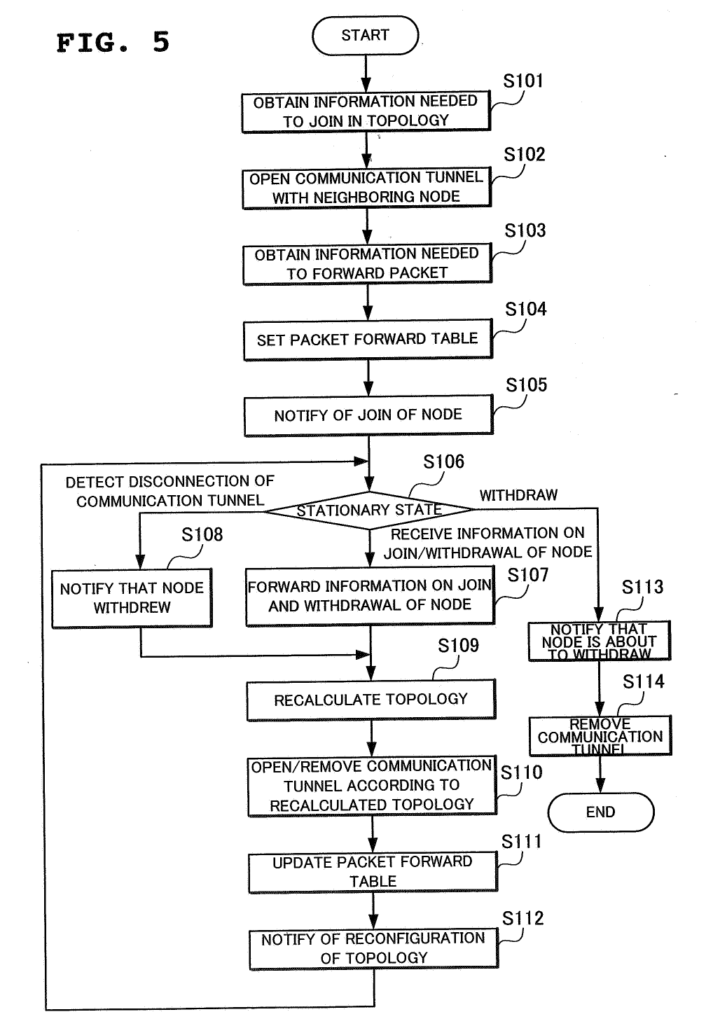

Next, referring to FIG. 5, in the present mode of implementation, operation when the node A21 joins the virtual LAN and operation after joining will be described in detail.

Firstly, the bootstrap unit A2154 within the node A21 connects to any of the nodes that join in the virtual LAN, and obtains the information needed for the current node to join in the topology configured on the virtual LAN (Step S101 in FIG. 5). For example, when a grid graph topology shown in FIG. 4 is configured among the nodes that join in the virtual LAN, which will be the ID born by the node under which the node A21 joins and which of the other nodes it should establish the communication tunnel with will differ depending on the current number of nodes.

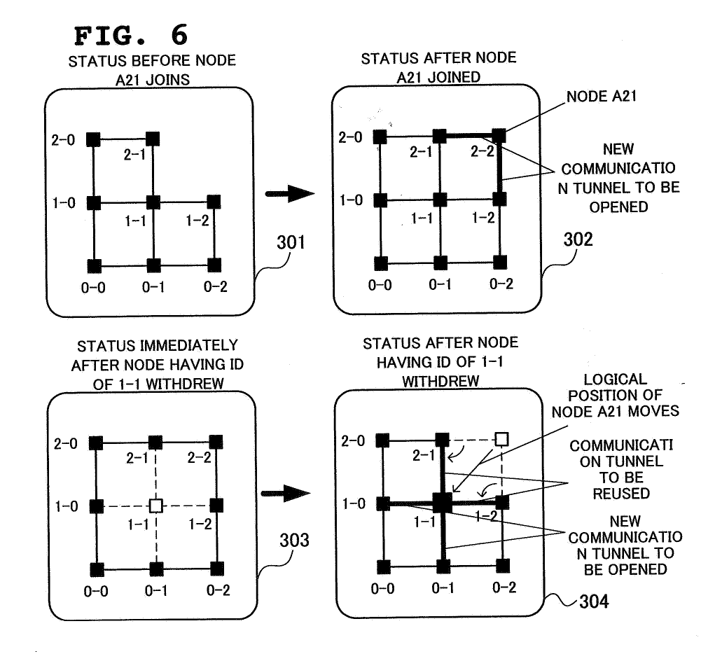

Referring to FIG. 6, an operation in which the node A21 newly joins in the grid graph topology configured by eight nodes will be described. An ID is assigned to each node in the grid graph topology, the ID of each node being determined, with the node ID at the bottom left corner being 0-0, as (position in the upward direction)-(position in the rightward direction) from this node (refer to Status 301). From node 0-0, the nodes are added in the order of 0-1->1-0->1-1->0-2->1-2->2-0->2-1, and the next joining node has the ID of 2-2. A11 the nodes from 0-0 to 2-1 hold the current number of nodes joining in the virtual LAN, and the ID of the next node to join in the virtual LAN, and the base IP addresses of the neighboring nodes this node should establish a communication tunnel with, are held via control message exchange within the virtual LAN.

When the node A21, through the bootstrap A2154, requests any node among nodes 0-0 to 2-1 to join in the virtual LAN, the requested node responds with the node ID assigned to the node A21, and which node the tunnel should be established for. In this case, the requested node responds that the node ID is 2-2, and the communication tunnel should be opened for the base IP address corresponding to the node 1-2 and node 2-1.

In Step S101, when the bootstrap A2154 obtains the information on the node for which a communication tunnel should be opened in order for the node to join in the virtual LAN, the information is passed to the virtual LAN status management unit A2151. Then, the virtual LAN status management unit A2151, through the tunnel control unit A2152, directs the virtual interface A214 to open the communication tunnel for the node for which the information was obtained and communication tunnel should be opened, and the communication tunnel is opened (Step S102). After Step S102, the status becomes the status 302 in FIG. 6.

After Step S102, the virtual LAN status management unit A2151 joins in the virtual LAN to obtain information needed to perform packet forward using the control message sending/receiving unit A2142 (Step S103). The information needed to perform packet forward refers to the correspondence relationship between the MAC address of each node within the virtual LAN (refers to the MAC address assigned to the virtual interface) and the node ID. Using this correspondence relationship, the virtual LAN status management unit A2151 creates a packet forward table A2141 that indicates which sub-interface the packet should be sent to for the destination MAC address of the packet (Step S104).

The creation of the packet forward table A2141 is performed on a regular basis, depending on the type of the topology to be used. For example, in the case of the grid graph topology shown in FIG. 6, to which communication tunnel the forward should be in order to reach the destination node in the smallest number of hops can be determined uniquely based on the destination node ID, such that creating a routing table on a regular basis is possible. The packet forward table is created in such a way that, in the node where the node ID is 2-2, packets are forwarded to the communication tunnel on the 1-2 side for the destination MAC addresses corresponding to the nodes that have IDs of 0-2 and 1-2, and packets are forwarded to the communication tunnel on the 2-1 side for the destination MAC addresses corresponding to the nodes that have other IDs (here, if the number of hops is the same when forwarding to either communication tunnels, the communication tunnel on the 2-1 side takes precedence).

In addition, entries for broadcast are created in the packet forward table A2141 at the same time for forward of ARP packets or the like. In the case of the spanning tree topology shown in FIG. 4, forwarding to all the communication tunnels other than the receiving communication tunnel is sufficient; however, in the case of other topologies, since a node must not receive the same packet redundantly, the transmission destination communication tunnel must be changed according to the source node of the broadcast packets, such that entries corresponding to broadcast packets are created as shown in the example of the packet forward table 101 in FIG. 3.

After Step S104, the virtual LAN status management unit A2151 sends a control message through the control message sending/receiving unit A2142 to notify other nodes within the virtual LAN that the node A21 has joined (Step S105). The other nodes that have received via the notification the control message notifying that the node A21 has joined perform the operations of Steps S107 and S109-S112 described below, if necessary, open and remove communication tunnels, and update the packet forward table A2141 so that it corresponds to the topology after the node A21 joined. After Step S105, the node A21 enters a stationary state, and can perform data communication with the other nodes as a joining node in the virtual LAN (Step S106).

Events that occur in the stationary state in Step S106 are divided into three: the first when a notification that another node has joined/withdrawn is received, the second when detecting that a communication tunnel with a neighboring node has been disconnected, and the third when the node A21 withdraws from the virtual LAN.

When a notification that another node has joined/withdrawn is received, the control message sending/receiving unit A2142 passes the notification to the virtual LAN status management unit A2151, and forwards the notification to the other nodes (Step S107). The notification is brought around to the knowledge of all the nodes within the virtual LAN, either using broadcasting, or a method to forward the notification to all the communication tunnels other than the receiving communication tunnel (in this case, if a redundant notification is received, the notification is discarded).

In addition, when a disconnection of the communication tunnel with a neighboring node is detected, the virtual LAN status management unit A2151 notifies the other nodes within the virtual LAN that the neighboring node withdrew from the virtual LAN, through the control message sending/receiving unit A2142 (Step S108).

After Step S107 or Step S108, the virtual LAN status management unit A2151 calculates the topology of the virtual LAN after the join and withdrawal of the nodes corresponding to the notification, using the topology calculation unit A2153 (Step S109).

An example of topology update will be described by referring to FIG. 6. The status 303 in FIG. 6 is a grid graph topology that consists of nine nodes having the IDs of 0-0˜2-2, and it is assumed that the node 1-1 has withdrawn.

The node A21 having an ID of 2-2 receives a notification from another node that the node 1-1 has withdrawn. The notification is passed from the control message sending/receiving unit A2142 to the virtual LAN status management unit A2151, and the virtual LAN status management unit A2151 calculates the topology corresponding to the fact that the node 1-1 has withdrawn, using the topology calculation unit A2153. Since the total number of the nodes is reduced from 9 to 8 when the management unit A2151 updates the packet forward table A2141 to suit the new topology (Step S111), and notifies all of the other nodes within the virtual LAN that the topology has been reconfigured, using the control message sending/receiving unit A2142 (Step S112). The nodes that have received the notification update the packet forward table to suit the reconfigured topology.

After Step S112, the node A21 becomes able to communicate with the other nodes within the virtual LAN again, as the node having the ID of 1-1. In other words, the state returns to the stationary state of Step S106.

In addition, from the stationary state of Step S106, if the node A21 withdraws from the virtual LAN, the virtual LAN status management unit A2151 sends a notification of the withdrawal within the virtual LAN through the control message sending/receiving unit A2142, and removes the established communication tunnel to perform the withdrawal from the virtual LAN (Steps S113 and S114). The node A21 may withdraw from the virtual LAN without the notification of withdrawal because of a power failure or the like, in this case, the neighboring node to the node A21 detects the disconnection of the communication tunnel with the node A21, and performs steps from Step S108 to operate the virtual LAN without interruption.

In the present mode of implementation, operation when the node A21 joins the virtual LAN and operation after joining have been described.

Another mode of implementation conceivable from the present mode of implementation will also be described below.

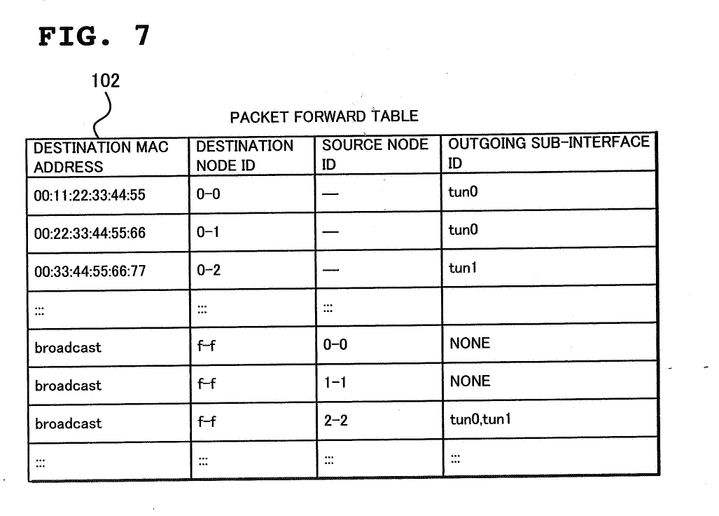

In the present mode of implementation, the packet forward table A2141 adopts a MAC address-based table structure as did the packet forward table 101 shown in FIG. 3. This is because the packet forward within the virtual LAN must be performed using the information contained in the MAC header, when the MAC header is encoded directly inside the encapsulated header as is the case in the packet format 401 shown in FIG. 8. However, when a new header is added for packet forward (header for forward) as is the case in the packet format 402 in FIG. 8, the packet forward can be performed based on the information contained in the header for forward, thus, adopting the MAC address-based table structure is not necessarily required. When the source node ID and the destination node ID of the packet are encoded in the header for packet forward, a node ID-based table structure can be adopted. Examples are shown in the packet forward table 102 in FIG. 7.

In the packet forward table 102, outgoing sub-interface IDs are registered in association with MAC addresses, destination node IDs and source node IDs. Among these, the node ID and the outgoing sub-interface ID associated with the destination MAC address are resolved at the source node of the packet. During the encapsulation of the packet, encoding is performed with the resolved node ID as the destination node ID and the node ID of the current node as the source node ID, which are sent from the resolved sub-interface ID. At an intermediate node that has received the packet, in the virtual interface A214, the destination node ID encoded in the packet is looked-up to resolve the associated outgoing sub-interface ID, and the packet is forwarded over the resolved sub-interface. Although only the destination node ID is looked-up for unicast packets, for broadcast packets, in order to prevent the same packets from being received redundantly, the outgoing sub-interface ID is resolved by also looking-up the source node ID at the same time.

Next, the effects of the present mode of implementation will be described.

In the present mode of implementation, communication tunnels are established autonomously between nodes joining in the virtual LAN, thereby configuring a topology and constructing a virtual LAN. In prior art, a virtual hub is needed to provide a virtual LAN; however, the present mode of implementation allows a virtual LAN of any number of nodes to be constructed without any pre-ready virtual hub. Thus, an effect is the ability to reduce the setup and operational costs of the virtual hub, when providing a virtual LAN.

In addition, since communication within the virtual LAN is performed based on a packet forward table created in each node according to the configured topology, concentration of traffic loads and processing loads on only one particular node (virtual hub) does not happen as in prior art. By selecting a topology that is appropriate so as to place the loads as equally as possible on each communication tunnel, high scalability can be provided against an increase in the number of nodes and traffic within the virtual LAN.

In addition, in the present mode of implementation, even if any of joining nodes withdraws, the virtual LAN topology is restored autonomously. Although the virtual hub was a single failure point in prior art, in the present mode of implementation, the communication between nodes joining in the virtual LAN can be carried on even against a withdrawal or a failure of any node, allowing a highly reliable system to be provided.

### Embodiment

Next, an embodiment of the present invention will be described by referring to drawings. Such an embodiment corresponds to an embodiment for implementing the present invention.

In the embodiment, a virtual LAN is constructed using the grid graph topology 202 shown in FIG. 4, and, in the initial status, this topology consists of eight nodes shown in state 301 in FIG. 6.

The node A21 in FIG. 2 newly joins in the virtual LAN. The information needed to join in the virtual LAN is the number of nodes joining in the virtual LAN, and the base IP address of the partner node for which the newly joining node should open a communication tunnel; in the embodiment, these data is resolved using DNS.

To resolve the number of nodes currently joining in the virtual LAN and the base IP address of the partner node for which the newly joining node should open the communication tunnel, using the DNS, the node about to join in the virtual LAN performs the following operations.

Firstly, the node that has the ID of 0-0 registers with a DNS server D1 the number of nodes currently joining in the virtual LAN. The number of nodes is recorded as a TXT (text) record corresponding to “nodenum.lan-a.net”. The registration operation is performed each time a change in the number of nodes within the virtual LAN is detected. Then, each node registers the base IP address of the current node with the DNS server D1. For example, when the current node ID is 2-1, and the base IP address is 8.9.10.11, “8.9.10.11” is registered with the DNS server D1 as a TXT record corresponding to “node2-1.lan-a.net”. This registration operation is performed following a change in the ID and the base IP address of the current node.

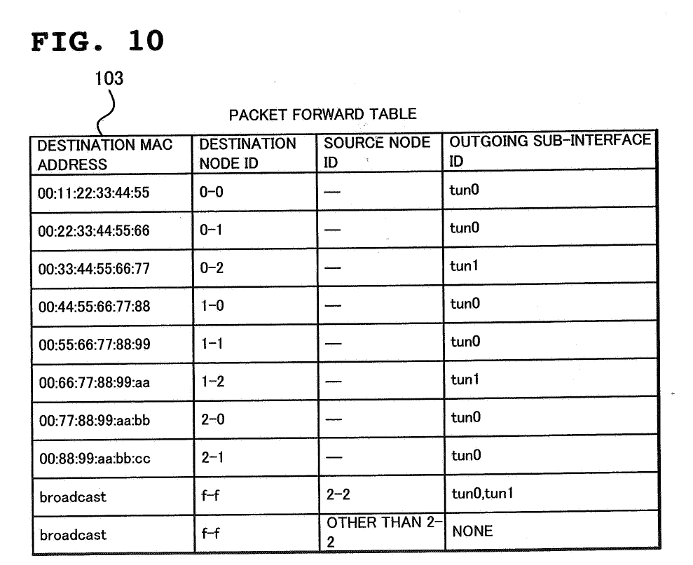

Referring to the sequence in FIG. 9, the bootstrap unit A2154 of the node A21 first resolves the TXT record for the domain name “nodenum.lan-a.net” with the DNS server D1 to resolve the current number of nodes within the virtual LAN. The DNS server D1 returns the response “eight nodes”. The bootstrap unit A2154 determines, via the topology calculation unit A2153, that the virtual LAN has a topology currently consisting of nodes having IDs of 0-0˜2-1, as shown in status 301 in FIG. 6, and that the node A21 should join in the virtual LAN as a node having the ID 2-2. In a grid graph topology, since a node having the ID of 2-2 will have virtual links with the node 2-1 and the node 1-2, the bootstrap unit A2154 then resolves the base IP addresses of the node 2-1 and the node 1-2 using the DNS to open the communication tunnels with the node 2-1 and the node 1-2.

In the sequence shown in FIG. 9, it is assumed that the TXT records for “node2-1.lan-a.net” and “node1-2.lan-a.net” are resolved, and the responses “8.9.10.11” and “6.7.8.9” are returned, respectively, from the DNS server D1.

The bootstrap unit A2154 passes to the virtual LAN status management unit A2151 the base IP addresses obtained from the DSN server, of the partner nodes for which the node A21 should open the communication tunnels, and the virtual LAN status management unit A2151 opens the communication tunnels through the tunnel control unit A2152. As a result of the opening of the communication tunnels, the virtual LAN has the topology shown in status 302 in FIG. 6. Although the opened communication tunnel is terminated by the sub-interface A2143 at the node A21, the ID of the sub-interface that terminates the communication tunnel with the node 2-1 is herein set to tun0, and the ID of the sub-interface that terminates the communication tunnel with the node 1-2 is set to tun1.

In the embodiment, it is assumed that the communication tunnel adopts the Ethernet over UDP format, as shown in the packet format 402 in FIG. 8, and that a header for forward is added between the outer UDP header and the inner MAC header. The header for forward includes the source node ID and the destination ID of the packet.

Then, the virtual LAN status management unit A2151 requests from either the node 2-1 or the node 1-2, which are neighboring nodes, the information needed by the node A21 to forward packets in the virtual LAN (packet forward information). The request is made through the control message sending/receiving unit A2142. It is assumed here that the packet forward information is requested from the node 2-1.

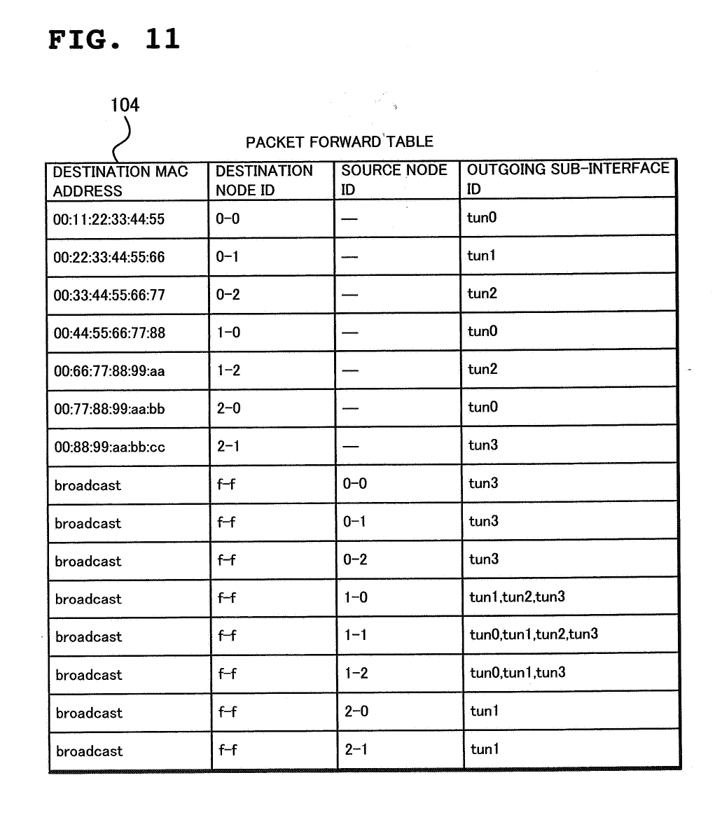

When the node 2-1 receives the request for the packet forward information from the node A21, the node 2-1 responds with a list of node IDs and MAC addresses of the nodes joining in the virtual LAN, which is kept within the node 2-1. The returned information is passed from the control message sending/receiving unit A2142 to the virtual LAN status management unit A2151, and the virtual LAN status management unit A2151 creates a packet forward table A2141 based on the information. The contents of the packet forward table created herein is shown in the packet forward table 103 in FIG. 10. In the packet forward table 103, the outgoing sub-interface ID for unitcast packets is registered for each destination node 0-0 to node 2-1. In addition, for broadcast packets, the outgoing sub-interface IDs are registered for each source node ID of the packet.

After the packet forward table A2141 has been created, the virtual LAN status management unit A2151 notifies the other nodes with the message that the join operation of the node A21 is completed, through the control message sending/receiving unit A2142. A method is adopted, wherein the message is first passed to the neighboring node 2-1, and then the node 2-1 notifies of the message the other nodes joining in the virtual LAN through the broadcast. The message contains the node ID and the MAC address of the node A21.

The message that notifies of the join of the node A21 is received by each node within the virtual LAN, and each node updates the packet forward table within itself using the node ID and the MAC address of the node A21 contained in the message. This update operation allows each node within the virtual LAN to communicate with the node A21, and the node A21 serves as one joining node within the virtual LAN.

Next, it is assumed that the node 1-1 has withdrawn from the virtual LAN in which the node A21 is joining, as shown in the status 303 in FIG. 6.

In this case, any among the nodes 0-1, 1-0, 1-2 and 2-1, which are neighboring the node 1-1, first detects the withdrawal of the node 1-1. This detection is achieved by using a mechanism, such as keep alive. The node 0-1 is the first to detect the withdrawal of the node 1-1, and the virtual LAN status management unit within the node 1-1 notifies the other nodes, through the control message sending/receiving unit, with a message that the node 1-1 withdrew. The message is forwarded at each node within the virtual LAN one after another in such a form that it is forwarded to all the sub-interfaces other than the sub-interface that received the message. Such a forward mode is called flooding, and when messages are forwarded by flooding, a node may receive redundantly a message it has already received once. Thus, the redundantly received message is discarded to prevent the message from being forwarded in an endless loop.

When the node A21 receives the message that the node 1-1 withdrew, the message is passed from the control message sending/receiving unit A2142 to the virtual LAN status management unit A2151. The virtual LAN status management unit A2151 uses the topology calculation unit A2153 to calculate the topology in the case where the node 1-1 has withdrawn. Here, it is assumed that p is calculated with the rule that, when the node ID is x−y, p=x2+x+y+1 for the nodes where x=max(x, y) and p=y2+x+1 for the other nodes,

and the node for which the value of p matches the number of nodes before the node 1-1 withdrawal logically moves to where the node that withdrew was, to reconfigure the topology (max(x, y) means the larger value of x or y). In this case, since the number of nodes before the withdrawal of the node 1-1 is nine, and if the ID is 2-2 it follows that p=9, the topology calculation unit A2153 calculates that the current node (node A21) should logically move to the position of the node 1-1. In the other nodes, since the value of p does not match the number of nodes before the withdrawal of the node 1-1, they determine themselves not to perform topology reconfiguration.

Then, through the tunnel control unit A2152, the virtual LAN status management unit A2151 opens and removes the communication tunnels for logically moving the current node to the position of the node 1-1. At the position of node 1-1, the communication tunnels with the nodes 0-1, 1-0, 1-2 and 2-1 should be kept. Since the node A21 already maintains the communication tunnels with the nodes 1-2 and 2-1, new communication tunnels for the nodes 0-1 and 1-0 are opened, and no communication tunnel removal operation is performed.

When communication tunnel opening/removal operation for topology reconfiguration is completed, in the node A21, sub-interface ID reassignments take place in the sub-interface A2143, and it is assumed here that the ID of the sub-interface that terminates the communication tunnel with the node 1-0 is tun0, the ID of the sub-interface that terminates the communication tunnel with the node 0-1 is tun1, the ID of the sub-interface that terminates the communication tunnel with the node 1-2 is tun2, and the ID of the sub-interface that terminates the communication tunnel with the node 2-3 is tun3.

The virtual LAN status management unit A2151 then updates the packet forward table A2141 to suit the modified topology. Here, the table is updated as shown in the packet forward table 104 in FIG. 11.

When the packet forward table A2141 is updated, the virtual LAN status management unit A2151 notifies the other node within the virtual LAN by broadcast through the control message sending/receiving unit A2142 with a message that the topology has been reconfigured, and that the node A21 moved as a node that has ID 1-1. The message contains the node ID and the MAC address of the node A21. The node that has received the message updates the packet forward table within the current node using the node ID and the MAC address contained in the received message. Through this operation, each node within the virtual LAN can communicate with each other in the reconfigured topology after the withdrawal of the node 1-1.

Although the modes of implementation and embodiments of the present invention have been described, the present invention is not limited only to the above modes of implementation and embodiments, and any other additions and modifications can be made. The abilities of the node device of the present invention can be achieved obviously hardware-wise, as well as using computers and programs. Programs are recorded and provided on a computer readable storage media such as magnetic disks and semiconductor memory, and read by a computer such as at start-up of the computer to control the operation of the computer, thereby causing the computer to serve as function means for the virtual interface A214, the virtual LAN control unit A215, or the like, of the nodes in each of the above-mentioned modes of implementation and embodiments.

A first effect of the present invention is the ability to construct a virtual LAN at a low cost.

The reason is, in the node device of the present invention and a virtual LAN system constructed using the same, the data link layer packets that are sent from a node joining in the virtual LAX to other joining nodes are configured in such a way that they are delivered through a communication tunnel if a communication tunnel is directly established between the sending/receiving nodes, and delivered through one or more other joining nodes that join in the virtual LAN if no communication tunnel is directly established between the sending/receiving node devices, eliminating the need for a conventional virtual hub, thus allowing the setup and operational costs of virtual hub to be reduced.

A second effect is the ability to provide a highly scalable virtual LAN.

The reason is, in the node device of the present invention and a virtual LAN system constructed using the same, communication within the virtual LAN is performed based on a packet forward table that is created in each node according to a configured topology, thus traffic loads and processing loads do not concentrate on only one particular node.

A third effect is the ability to provide a highly reliable virtual LAN.

The reason is, in the node device of the present invention and a virtual LAN system constructed using the same, the topology of the virtual LAN is autonomously restored against the withdrawal and failure of any joining node, thereby allowing the communication between the nodes joining in the virtual LAN to be carried on.

1. A virtual LAN system for providing a virtual LAN which is a LAN constructed virtually by encapsulating a data link layer packet using a communication tunnel, wherein
a node device joining in said virtual LAN comprises a virtual interface for emulating, as a virtual link in the virtual LAN, the communication tunnel for encapsulating said data link layer packet, said virtual interface comprising a plurality of sub-interfaces for terminating communication tunnels established for other node devices in said virtual LAN, and a packet forward table in which sub-interfaces are registered from which sub-interface among said plurality of sub-interfaces to send or forward said data link layer packet that the current node device is to send and said data link layer packet received from another node device in said virtual LAN, according to a virtual LAN topology in which the node devices joining in said virtual LAN are connected by said communication tunnels,
and said data link layer packet that is sent from the node device joining in said virtual LAN to another node device joining in said virtual LAN is configured so as to be delivered through said communication tunnel if said communication tunnel is directly established between the sending/receiving node devices, and delivered through one or more node devices joining in said virtual LAN if said communication tunnel is not directly established between the sending/receiving node devices.

2. The virtual LAN system as claimed in claim 1, wherein the node device joining in said virtual LAN comprises a virtual LAN control unit for, when the node device detects the withdrawal of another node device joining in said LAN from said virtual LAN, recalculating a virtual LAN topology after said withdrawal, and opening and removing said communication tunnel to suit the recalculated virtual LAN topology, and for changing the setting of said packet forward table.

3. The virtual LAN system as claimed in claim 1, wherein the node device joining in said virtual LAN comprises a virtual LAN control unit for, when the node device detects the join of a new node device in said virtual LAN, recalculating a virtual LAN topology after said join, and opening and removing said communication tunnel to suit the recalculated virtual LAN topology, and for changing the setting of said packet forward table.

4. The virtual LAN system as claimed in claim 1, 2 or 3, wherein a node ID unique in said virtual LAN is assigned to the node device joining in said virtual LAN, an outgoing sub-interface ID associated with a MAC address of the node device joining in said virtual LAN, a destination node ID and a source node ID is registered with said packet forward table of the node device joining in said virtual LAN, said data link layer packet is encoded with the node ID of the source node and the destination node of said data link layer packet during encapsulation, and said virtual interface forwards said data link layer packet based on the node IDs of said encapsulated source node and destination node.

5. A virtual LAN system for providing a virtual LAN which is a LAN constructed virtually by encapsulating a data link layer packet using a communication tunnel, wherein
a virtual interface of a node device joining in said virtual LAN comprises a plurality of sub-interfaces for terminating communication tunnels established for other node devices in said virtual LAN, in which sub-interfaces are registered from which sub-interface to send or forward said data link layer packet that the current device is to send and said data link layer packet received from another node device in said virtual LAN, according to a virtual LAN topology in which the node devices joining in said virtual LAN are connected by said communication tunnels,
and said data link layer packet that is sent from the node device joining in said virtual LAN to another device joining in said virtual LAN is configured so as to be delivered through said communication tunnel, or delivered through one or more other node devices joining in said virtual LAN, depending on the presence of a direct establishment of said communication tunnel between the sending/receiving node devices.

6. The virtual LAN system as claimed in claim 5, wherein said virtual interface comprises a packet forward table in which sub-interfaces are registered from which sub-interface among said plurality of sub-interfaces to send or forward said data link layer packet that the current node device is to send and said data link layer packet received from another node device in said virtual LAN, according to a virtual LAN topology in which the node devices joining in said virtual LAN are connected by said communication tunnels.

7. A node device, comprising
a virtual interface for emulating, as a virtual link in the virtual LAN, a communication tunnel for encapsulating a data link layer packet, wherein
said virtual interface comprising a plurality of sub-interfaces for terminating communication tunnels established for other node devices in said virtual LAN, and a packet forward table in which sub-interfaces are registered from which sub-interface among said plurality of sub-interfaces to send or forward said data link layer packet that the current node device is to send and said data link layer packet received from another node device in said virtual LAN, according to a virtual LAN topology in which the node devices joining in said virtual LAN are connected by said communication tunnels, wherein
said virtual interface sending or forwarding said data link layer packet that the current node is to send and said data link layer packet received from another node in said virtual LAN from a sub-interface that is determined by referring to said packet forward table.

8. The node device as claimed in claim 7, comprising a virtual LAN control unit for, when the node device detects the withdrawal of another node device joining in said LAN from said virtual LAN, recalculating a virtual LAN topology after said withdrawal, and opening and removing said communication tunnel to suit the recalculated virtual LAN topology, and for changing the setting of said packet forward table

9. The node device as claimed in claim 7, comprising a virtual LAN control unit for, when the node device detects the join of a new node device in said virtual LAN, recalculating a virtual LAN topology after said join, and opening and removing said communication tunnel to suit the recalculated virtual LAN topology, and for changing the setting of said packet forward table.

10. The node device claimed in claim 7, 8 or 9, wherein an outgoing sub-interface ID associated with a MAC address of the node device joining in said virtual LAN, a destination node ID and a source node ID is registered with said packet forward table, said data link layer packet is encoded with the node ID of the source node and the destination node of said data link layer packet during encapsulation, and said virtual interface forwards said data link layer packet based on the node IDs of said encapsulated source node and destination node.

11. The node device claimed in any one claim of claims 7 to 10, comprising a bootstrap unit that has a function to obtain information as to for which node that is already joining in said virtual LAN said communication tunnel should be opened, when the node device tries to join in said virtual LAN.

12. A node device, comprising:
a virtual interface for emulating, as a virtual link in the virtual LAN, a communication tunnel for encapsulating a data link layer packet, wherein
said virtual interface comprising a plurality of sub-interfaces for terminating communication tunnels established for other node devices in said virtual LAN, in which sub-interfaces are registered from which sub-interface to send or forward said data link layer packet that the current device is to send and said data link layer packet received from another node device in said virtual LAN, according to a virtual LAN topology in which the node devices joining in said virtual LAN are connected by said communication tunnels.

13. The node device claimed in claim 12, wherein said virtual interface comprises a packet forward table in which sub-interfaces are registered from which sub-interface among said plurality of sub-interfaces to send or forward said data link layer packet that the current node device is to send and said data link layer packet received from another node device in said virtual LAN,
and sends or forwards said data link layer packet that the current node is to send and said data link layer packet received from another node in said virtual LAN from a sub-interface that is determined by referring to said packet forward table.

14. A program which operates a computer constituting a communication node
as a virtual interface for emulating, as a virtual link in the virtual LAN, a communication tunnel for encapsulating a data link layer packet, said virtual interface comprising a plurality of sub-interfaces for terminating communication tunnels established for other node devices in said virtual LAN, and sending or forwarding said data link layer packet that the current node is to send and said data link layer packet received from another node in said virtual LAN from a sub-interface that is determined by referring to a packet forward table in which sub-interfaces are registered from which sub-interface among said plurality of sub-interfaces to send or forward said data link layer packet that the current node device is to send and said data link layer packet received from another node device in said virtual LAN, according to a virtual LAN topology in which the node devices joining in said virtual LAN are connected by said communication tunnels.

15. The program as claimed in claim 14, which further causes said computer to serve as a virtual LAN control means for, when the node device detects the withdrawal of another node device joining in said virtual LAN from said virtual LAN, recalculating a virtual LAN topology after said withdrawal, and opening and removing said communication tunnel to suit the recalculated virtual LAN topology, and for changing the setting of said packet forward table.

16. The program as claimed in claim 14, which further causes said computer to serve as a virtual LAN control means for, when the node device detects the join of a new node device in said virtual LAN, recalculating a virtual LAN topology after said join, and opening and removing said communication tunnel to suit the recalculated virtual LAN topology, and for changing the setting of said packet forward table.

17. A program executed on a computer constituting a communication node,
said program operates
a virtual interface for emulating, as a virtual link in the virtual LAN, a communication tunnel for encapsulating a data link layer packet, which virtual interface comprises a plurality of sub-interfaces for terminating communication tunnels established for other node devices in said virtual LAN, as a virtual interface for determining any of sub-interface among said plurality of sub-interfaces to send or forward said data link layer packet that the current node device is to send and said data link layer packet received from another node device in said virtual LAN, according to a virtual LAN topology in which the node devices joining in said virtual LAN are connected by said communication tunnels.

18. The program claimed in claim 17, which causes said virtual interface
to serve as a virtual interface for determining a sub-interface from said plurality of sub-interfaces to send or forward said data link layer packet by referring to a packet forward table in which sub-interfaces are registered from which sub-interface among said plurality of sub-interfaces to send or forward said data link layer packet that the current node device is to send and said data link layer packet received from another node device in said virtual LAN, according to a virtual LAN topology in which the node devices joining in said virtual LAN are connected by said communication tunnels.
